(19) United States
(12) Patent Application Publication
(10) Pub. No.: US 2022/0221584 A1
(43) Pub. Date: Jul. 14, 2022

(54) LASER RADAR AND METHOD FOR GENERATING LASER POINT COULD DATA

(71) Applicant: RAYZ TECHNOLOGIES CO. LTD., Beijing (CN)

(72) Inventors: Ruxin Chen, Beijing (CN); Detao Du, Beijing (CN)

(73) Assignee: RAYZ TECHNOLOGIES CO. LTD., Beijing (CN)

(21) Appl. No.: 17/707,679

(22) Filed: Mar. 29, 2022

Related U.S. Application Data
(63) Continuation of application No. PCT/CN2020/118644, filed on Sep. 29, 2020.

(30) Foreign Application Priority Data
Sep. 29, 2019 (CN) 201910932355.7

(51) Int. Cl. G01S 17/89; G01S 7/481

(52) U.S. Cl. CPC G01S 17/89; G01S 7/4817; G01S 7/4815

(57) ABSTRACT

A laser radar (100) and a method (6000) for generating laser point cloud data. The laser radar (100) comprises: a laser transceiver (110), wherein the laser transceiver (110) comprises a laser emitter and a laser receiver, the laser receiver determines distance information (111) of the laser transceiver (110) away from an object on the basis of laser emitted by the laser emitter and reflected by the object, and the laser transceiver (110) does not record orientation information (112) of the object; a position sensor (120), the position sensor (120) determining the orientation information (112) of the object on the basis of the laser reflected by the object; and a processor (130), the processor (130) communicating with the laser transceiver (110) and the position sensor (120) and obtaining the laser point cloud data of the object on the basis of the distance information (111) and the orientation information (112).

### CROSS-REFERENCE TO RELATED APPLICATIONS

This patent application is a continuation of International Application No. PCT/CN2020/118644, filed on Sep. 29, 2020, which claims priority to Chinese patent Application No. 201910932355.7, filed in the National Intellectual Property Administration (CNIPA) on Sep. 29, 2019, the entire disclosure of which is hereby incorporated by reference.

### TECHNICAL FIELD

The present disclosure relates to the field of measurement and testing, and in particular, to a laser radar and a method for generating laser point cloud data.

### BACKGROUND

As an important sensing tool, laser radar (LIDAR) plays an increasingly important role in many fields. For example, in the current field of unmanned driving, laser radar is used as an important sensing tool.

### SUMMARY

The present disclosure provides a laser radar. The laser radar includes: a laser transceiver, where the laser transceiver includes a laser emitter and a laser receiver, the laser receiver determines distance information of the laser transceiver away from an object based on laser emitted by the laser emitter and reflected by the object; a position sensor, the position sensor determining orientation information of the object based on the laser reflected by the object; and a processor, the processor communicating with the laser transceiver and the position sensor respectively, and obtaining laser point cloud data of the object based on the distance information and the orientation information.

According to embodiments of the present disclosure, the laser transceiver comprises at least two sets of laser transceivers, and the at least two sets of laser transceivers scan independently of each other.

According to embodiments of the present disclosure, the laser transceiver has a nonuniform scanning step size.

According to embodiments of the present disclosure, the at least two sets of laser transceivers nonuniformly divide a total field-of-view of the laser radar.

According to embodiments of the present disclosure, a wavelength of laser corresponding to each set of laser transceivers of the at least two sets of laser transceivers is different from a wavelength of laser corresponding to other laser transceivers.

According to embodiments of the present disclosure, a modulation of laser corresponding to each set of laser transceivers of the at least two sets of laser transceivers is different from a modulation of laser corresponding to other laser transceivers.

According to embodiments of the present disclosure, laser receivers of the each set of laser transceivers comprise filters that filter the laser corresponding to the other laser transceivers.

According to embodiments of the present disclosure, the laser radar comprises a scan driver corresponding to the laser transceiver, and the scan driver drives the laser transceiver to perform a random scanning operation without preset direction information of laser emission.

According to embodiments of the present disclosure, the scan driver comprises: at least one of a reflection mirror and a light transmission optics, the at least one of the reflection mirror and the light transmission optics controls an emission direction of the laser corresponding to the laser transceiver; and a motor, wherein the motor drives at least one of the reflection mirror and the light transmission optics to move randomly within a predetermined angle range.

According to embodiments of the present disclosure, the scan driver drives the laser transceiver to move randomly within a predetermined angle range through an optical path control device, or drives the laser transceiver to have a spatial angle change greater than 1.5 times a spatial angle change from a previous scan during at least one scan.

According to embodiments of the present disclosure, the optical path control device comprises at least one of: an optical phased array, a microelectromechanical system, a liquid crystal photoconductive device, a reflective liquid crystal light valve or a transmissive liquid crystal light valve.

According to embodiments of the present disclosure, the laser transceiver comprises at least two laser receivers that are spatially separated from each other.

According to embodiments of the present disclosure, the laser transceiver also determines light intensity information of the laser reflected by the object.

According to embodiments of the present disclosure, a number of pixels output by the position sensor is less than half of a total number of pixels of the position sensor and greater than a number of pixels corresponding to the laser reflected by the object in each measurement.

According to embodiments of the present disclosure, the position sensor comprises a CMOS image sensor, a CCD image sensor, and an APD array, and the position sensor determines the orientation information of the object based on the laser reflected by the object during an exposure duration.

According to embodiments of the present disclosure, the position sensor further comprises a clock counter, and the clock counter records a time that the laser reflected by the object reaches the transceiver in the exposure duration relative to an exposure start time.

According to embodiments of the present disclosure, the laser transceiver comprises at least two sets of laser transceivers, wherein at least one set of laser transceivers are Flash laser radars, and a field-of-view of the Flash laser radars is less than 0.75 times of a total field-of-view of a to-be-measured scenario measured by the laser radar.

The present disclosure provides a method for generating laser point cloud data, the method comprising: measuring, using a laser transceiver, distance information of an object away from the laser transceiver; measuring orientation information of the object based on a position sensor independent of the laser transceiver; and generating the laser point cloud data of the object based on the distance information and the orientation information.

According to embodiments of the present disclosure, the laser transceiver comprises a laser emitter and a laser receiver, and measuring the distance information comprises: emitting laser using the laser emitter; receiving the laser emitted by the laser emitter and reflected by the object; and determining the distance information based on a time of flight of the emitted and reflected laser.

According to embodiments of the present disclosure, the laser transceiver comprises at least two laser receivers that are spatially separated from each other, and measuring the distance information further comprises: determining jointly the distance information based on positions of the at least two laser receivers that are separated from each other and the time of flight.

According to embodiments of the present disclosure, the laser transceiver comprises at least two sets of laser transceivers, and the method comprises: configuring a different laser wavelength or modulation for each set of laser transceivers.

According to embodiments of the present disclosure, measuring the distance information further comprises: acquiring the distance information through scanning by the laser transceiver, wherein, the scanning is spatial random scanning.

According to embodiments of the present disclosure, the method further comprises: determining a material or a surface shape of the object based on light intensity information of the reflected laser.

According to embodiments of the present disclosure, measuring the orientation information of the object further comprises: recording the orientation information based on an intensity of a laser signal sensed within an exposure duration of the position sensor being greater than a predetermined threshold.

According to embodiments of the present disclosure, measuring the orientation information of the object comprises: recording the orientation information, in response to a number of regions of a set of lasers having a strongest laser light intensity of a laser signal sensed within an exposure duration of the position sensor being greater than a number of emitted laser sources, and an intensity of any laser in the strongest set of lasers being greater than 1.5 times an intensity of any laser in a non-strongest set of lasers.

According to embodiments of the present disclosure, wherein the method further comprises: recording a time that the laser reflected by the object reaches the transceiver in the exposure duration relative to an exposure start time, and assisting measuring the distance information based on the time.

The present disclosure also provides a system for generating laser point cloud data, and the system includes: a memory, storing computer-readable instructions; and a processor, connected to the memory, executing the instructions to perform operations as follows: controlling the laser transceiver to measure distance information of an object away from the laser transceiver; measuring orientation information of the object based on a position sensor independent of the laser transceiver; and generating the laser point cloud data of the object based on the distance information and the orientation information.

The present disclosure also provides a non-volatile computer storage medium, the computer storage medium stores computer program instructions, the instructions, when executed by a processor: sending an instruction to control a laser transceiver to measure distance information of an object away from the laser transceiver; measuring orientation information of the object based on a position sensor independent of the laser transceiver; and generating the laser point cloud data of the object based on the distance information and the orientation information.

### BRIEF DESCRIPTION OF THE DRAWINGS

Other features, objectives and advantages of the present disclosure will become more apparent by reading detailed descriptions of non-limiting embodiments made with reference to the following accompanying drawings:

FIG. 1A and FIG. 1B are schematic block diagrams of a laser radar according to an embodiment of the present disclosure;

FIG. 2 is a schematic diagram of a field-of-view of laser transceivers of a laser radar according to an embodiment of the present disclosure;

FIG. 3 is a schematic diagram of an operating mode of a scan driver according to an embodiment of the present disclosure;

FIG. 4 is a schematic block diagram of a laser transceiver according to an embodiment of the present disclosure;

FIG. 5 is a schematic diagram of an operating mode of a position sensor according to an embodiment of the present disclosure;

FIG. 6 is a flowchart of generating laser point cloud data according to an embodiment of the present disclosure; and

FIG. 7 is a block diagram of a processing circuit according to an embodiment of the present disclosure.

### DETAILED DESCRIPTION OF EMBODIMENTS

For a better understanding of the present disclosure, various aspects of the present disclosure will be described in more detail with reference to the accompanying drawings. It should be understood that these detailed descriptions are merely illustrative of exemplary embodiments of the present disclosure and are not intended to limit the scope of the present disclosure in any way. Throughout the specification, the same reference numerals refer to the same elements. The expression “and/or” includes any and all combinations of one or more of the associated listed items.

It should be noted that in this specification, the expressions first, second, third etc. are only used to distinguish one feature from another feature and do not indicate any limitation to the feature. Accordingly, a first laser transceiver discussed below may also be referred to as a second laser transceiver without departing from the teachings of the present disclosure. Vice versa.

In the accompanying drawings, the thickness, size and shape of components have been slightly adjusted for ease of illustration. The accompanying drawings are examples only and are not drawn strictly to scale. As used herein, the terms “approximately,” “about,” and similar terms are used as terms of approximation, not of degree, and are intended to account for inherent deviations in measured or calculated values that would be recognized by those of ordinary skills in the art.

It should also be understood that expressions such as “comprising,” “comprises,” “having,” “including,” and/or “includes” in this specification are open-ended rather than closed expressions, indicating the presence of stated features, elements and/or components, but do not exclude the presence of one or more other features, elements, components and/or combinations thereof. Furthermore, when an expression such as “at least one of” appears after a list of listed features, it modifies the entire list of features and not only individual elements of the list. Furthermore, when describing embodiments of the present disclosure, the use of “may” indicates “one or more embodiments of the present disclosure.” Also, the term “exemplary” is intended to refer to an example or illustration.

Unless otherwise defined, all terms (including engineering terms and scientific terms) used herein have the same meaning as commonly understood by those of ordinary skills in the art to which the present disclosure belongs. It should also be understood that, unless explicitly stated otherwise in the present disclosure, words defined in commonly used dictionaries should be construed as having meanings consistent with their meanings in the context of the related art, rather than idealized or overly formalized meanings.

It should be noted that embodiments in the present disclosure and features in the embodiments may be combined with each other on a non-conflict basis. In addition, unless clearly defined or contradicted by the context, the specific steps included in the methods described in the present disclosure are not necessarily limited to the described order, but may be performed in any order or in parallel. The present disclosure will be described below in detail with reference to the accompanying drawings and in combination with the embodiments.

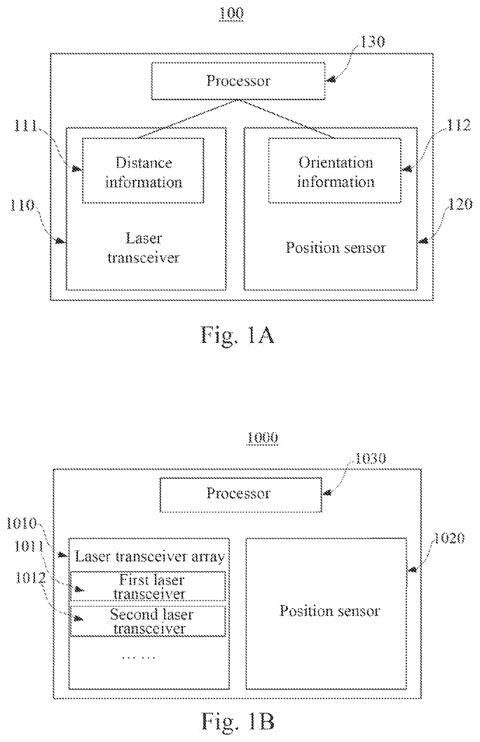

FIG. 1A shows a block diagram of a laser radar 100 according to an embodiment of the present disclosure. The laser radar 100 may be a single-source radar or a multi-source radar, the single-source radar may be a single-line radar or a single flash laser radar (Flash laser radar), and the multi-source radar may be a multi-line radar or a plurality of flash laser radars.

The laser radar 100 provided in the present disclosure includes a laser transceiver 110, a position sensor 120 and a processor 130. The laser transceiver 110 includes a laser emitter and a laser receiver. The laser receiver determines distance information 111 of the laser transceiver away from an object based on laser emitted by the laser emitter and reflected by the object. The position sensor 120 determines orientation information 112 of the object based on the laser reflected by the object. The processor 130 communicates with the laser transceiver 110 and the position sensor 120, and obtains laser point cloud data of the object based on the distance information 111 and the orientation information 112. According to an embodiment of the present disclosure, the orientation information of the object may be acquired by the position sensor. Therefore, there is no need for the laser transceiver to record the orientation information of the object. In this case, the design and machining accuracy of the laser transceiver may be reduced, thereby reducing a cost of the laser radar.

In general, a multi-line laser radar is generally composed of a plurality of single-line laser radars arranged in a regular array and rotates and scans synchronously. The multi-line laser radar emits a set of lasers every time it rotates a small angle. When the multi-line laser radar rotates over its designed angle range, a complete frame of data is generated. The data may be viewed as a multi-row lattice with varying heights, in a form similar to an image frame.

Each laser emitter in the conventional multi-line laser radar is equipped with a corresponding laser receiver. The laser receiver receives laser emitted by the same set of laser emitters and reflected by the object, and then uses information carried by the laser to determine information such as a material of the object and a distance between the object and the laser radar. In addition, a reflection point position of the object is determined by rotation angle information and distance information of the multi-line laser radar. In other words, during scanning of the laser radar, the rotation angle should be recorded continuously, and then the position of the laser reflection point should be restored by using the angle information and the distance information of the object.

Each laser emitter in the conventional multi-line laser radar has a certain angle and distance relationship with other laser emitters, and the relationship is kept invariant during the scanning. For example, each laser emitter in the conventional multi-line laser radar bisects a field-of-view (FOV) of the entire laser radar.

In order to avoid image distortion of the restored laser reflection point, the conventional multi-line laser radar still needs to ensure that a relative position (such as relative distance, relative angle) between each laser emitter remains unchanged during the scanning, and during the scanning, very high scanning step accuracy is required. This brings great challenges to the design and processing of the laser radar. Therefore, prices of 64-line and 128-line laser radars on the current market remain high.

FIG. 1B shows a multi-line laser radar 1000 according to an embodiment of the present disclosure. The laser radar 1000 includes a laser transceiver array 1010, a position sensor 1020 and a processor 1030. The laser transceiver array 1010 includes at least two sets of laser transceivers. The laser transceiver array 1010 is exemplarily shown in FIG. 1B to include a first laser transceiver 1011 and a second laser transceiver 1012. However, those skilled in the art may know that the laser transceiver array 1010 may be equipped with a corresponding number of laser transceivers based on application requirements. For example, in a vehicle-mounted main laser radar application scenario, the laser transceiver array 1010 may be equipped with 64, 128, or 256 laser transceivers. Here, at least one set of the laser transceivers may be Flash laser radars, and a field-of-view of the Flash laser radars is less than 0.75 times of a total field-of-view of a to-be-measured scenario measured by the laser radar.

According to the present disclosure, each set of laser transceivers may scan relatively independently of each other. For example, the first laser transceiver 1011 and the second laser transceiver 1012 do not have to scan in a synchronized way. The first laser transceiver 1011 and the second laser transceiver 1012 may respectively have their own scan drive mechanisms and scan according to different rules. As another example, the first laser transceiver 1011 and the second laser transceiver 1012 may scan in a weakly correlated way. The first laser transceiver 1011 and the second laser transceiver 1012 may have a certain amount of activity redundancy between each other, so that even if the first laser transceiver 1011 and the second laser transceiver 1012 are controlled by a common mechanical or electronic control mechanism to scan, the first laser transceiver 1011 and the second laser transceiver 1012 may not necessarily maintain a fixed relative angle and position. It should be understood that, in the present disclosure, the expression “relatively independently” or “independently” indicates that the scanning of the first laser transceiver 1011 and the second laser transceiver 1012 allows for some dislocations and non-correlations.

Each set of laser transceivers may include laser emitters and laser receivers. The laser receiver may, for example, employ an avalanche photodiode (APD). The laser emitters and the laser receivers of each set of laser transceivers may be paired with each other, so that the laser receivers of each set of laser transceivers can correspondingly receive laser emitted by the laser emitters of this set of laser transceivers and reflected by the object, thereby determining the distance information of this set of laser transceivers from the object. For example, the laser receiver may determine the distance between the laser transceiver and the object based on a time difference between the emitting and reception of the laser. This method of ranging is generally referred to as time-of-flight (TOF) ranging.

The position sensor 1020 determines orientation information of the object based on the laser reflected by the object. The position sensor 1020 is an image sensor independent of any laser transceiver in the laser transceiver array 1010. The position sensor 1020 independently collects laser reflection points on a surface of the object, and determines orientation information of these laser reflection points. The orientation information may be planar information. For example, the orientation information may not include depth/distance information, but only projected positions or azimuth angles of these reflection points on the position sensor. The position sensor 1020 may identify which laser emitter of the laser transceiver each laser reflection point originates from.

The processor 1030 communicates with the laser transceiver array 1010 and the position sensor 1020, and obtains laser point cloud data of the object based on the distance information and the orientation information. For example, the processor 1030 may correlate the distance information with the orientation information to generate three-dimensional (3D) laser point cloud data. The generated 3D laser point cloud data may reflect an environment detected by the laser radar. Since the position sensor 1020 records the orientation information of the object, the laser transceiver array 1010 may not record the orientation information of the object.

According to an embodiment of the present disclosure, the position sensor is used to collect the orientation information of the object. The ranging and orientation perception of the laser radar are respectively completed by different sensors. Therefore, in a process of establishing the laser point cloud data measured by the laser radar, it is not necessary to rely on the scanned position recorded during the scanning to restore the orientation of the object. In addition, the laser transceivers of the laser transceiver array may scan independently of each other without strictly scanning synchronously. The above solution improves a freedom of design and processing of the laser transceiver array, reduces signal processing and machining requirements of the laser transceiver array, thus significantly reduces the cost of the laser radar.

According to an embodiment of the present disclosure, the scanning of the laser transceiver may be nonuniform. Specifically, a step size of one frame of the laser transceiver in the scanning process may be different from a step size of another frame. For example, the step size of the first laser transceiver 1011 in a first frame may be different from its step size in a second frame. As described above, the orientation information may be collected based on the position sensor 1020. Therefore, in the process of establishing the laser point cloud data, it is not necessary to rely on the scanned position of the laser transceiver to determine the position of the laser reflection point of the object. In this case, the scanning of the laser transceiver may have a high degree of design freedom. For example, in the scanning of two consecutive frames, if the laser receiver does not detect any reflected laser signal, and the position sensor does not detect a corresponding laser reflection point, it may be determined that there is no object (or obstacle) in emission directions of the two frames of laser. In this case, a scan spacing (e.g., sweep angle) of a next frame may be increased. In subsequent two consecutive frames of scanning, if the laser receiver detects a reflected laser signal and the position sensor also detects a corresponding reflection point, it may be determined that an object (or obstacle) has been scanned. In this regard, the scan spacing (e.g., sweep angle) of a next frame may be reduced, so as to obtain dense sensing signals. This nonuniform scanning method may reduce the amount of data collection without significantly reducing a detection accuracy to the object, thereby reducing a burden of data transmission and processing, which is conducive to the application of laser radar to various application scenarios having high “real-time” requirements.

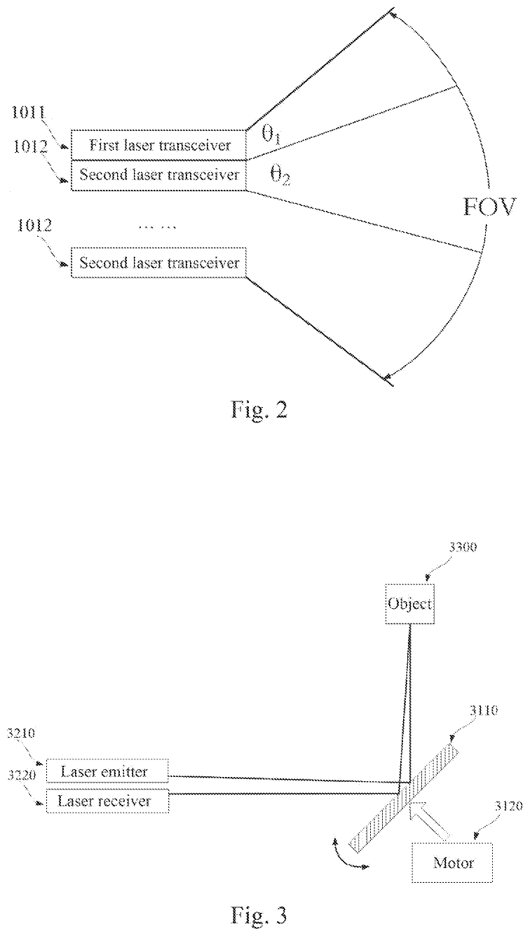

According to an embodiment of the present disclosure, each laser transceiver may nonuniformly divide a total field-of-view of the laser radar. Referring to FIG. 2, it is assumed that the laser radar has a total field-of-view FOV. The total field-of-view FOV may refer to either a horizontal field-of-view or a vertical field-of-view. For example, the total field-of-view FOV as shown in FIG. 2 may refer to FOV in a vertical direction when the laser radar rotates and scans along a vertical axis. Each laser transceiver may have its own main field-of-view. For example, the first laser transceiver 1011 has a first main field-of-view θ1, and the second laser transceiver 1012 has a second main field-of-view θ2. In the present disclosure, the main field-of-view refers to an angle range of an area that the laser transceiver is responsible for monitoring, not a physical maximum field-of-view of the laser transceiver. In order to ensure that each laser transceiver can completely cover the total field-of-view FOV, the physical maximum field-of-view of each laser transceiver should be greater than the main field-of-view of the laser transceiver.

According to an embodiment of the present disclosure, θ1 may not be equal to θ2. For example, when the total field-of-view is 40 degrees and the number of laser transceivers is 10, the main field-of-view of each laser transceiver may not have a field-of-view of 4 degrees in a way of equally dividing the 40 degrees. In this case θ1 may be equal to 5 degrees and θ2 may be equal to 3 degrees. In many application scenarios, not all field-of-view information is of equal importance. For example, it may be that the information of a middle field-of-view region is relatively more important and requires higher data accuracy, while the information of an edge field-of-view region is relatively unimportant and may allow for lower data accuracy. Therefore, laser transceivers of different density levels may be allocated to different field-of-view regions, thus taking into account both data accuracy and data burden.

According to an embodiment of the present disclosure, a wavelength of laser corresponding to each set of laser transceivers of the at least two sets of laser transceivers is different from a wavelength of laser corresponding to other laser transceivers. For example, a laser emitter of the first laser transceiver 1011 may emit a red laser at 633 nm, while a laser emitter of the second laser transceiver 1012 may emit a green laser at 543 nm. In this case, the laser receiver of each laser transceiver may include a filter, e.g., an optical filter, that filters the laser corresponding to the other laser transceivers. In this case, the laser emitters and the laser receivers of each set of laser transceivers may be matched one-to-one without data crosstalk. In addition, the position sensor 1020 may distinguish which set of laser transceivers each reflected laser beam comes from based on the wavelength of the laser reflected back from the object (in other words, a color of the laser reflection point on the object).

According to an embodiment of the present disclosure, a modulation of laser corresponding to each set of laser transceivers of the at least two sets of laser transceivers is different from a modulation of laser corresponding to other laser transceivers. For example, the laser emitter of the first laser transceiver 1011 may emit laser frequency modulated according to a first envelope, while the laser emitter of the second laser transceiver 1012 may emit laser frequency modulated according to a second envelope. In this case, the laser receiver of each laser transceiver may include a filter, e.g., a digital filter, that filters the laser corresponding to the other laser transceivers. In this case, the laser emitters and the laser receivers of each set of laser transceivers may be matched one-to-one without data crosstalk. In addition, the position sensor 1020 may distinguish which set of laser transceivers each reflected laser beam comes from based on the frequency modulation of the laser reflected back from the object.

According to an embodiment of the present disclosure, the scanning of laser radar may use mechanical scanning, electronic phased scanning or electromechanical hybrid scanning. The laser radar may include a scan driver corresponding to each set of laser transceivers, and the scan driver drives the laser transceiver to scan randomly. An implementation process of this random scanning is further elaborated below in the form of mechanical scanning. However, those skilled in the art can understand that other scanning techniques may also be implemented according to this technical concept.

Referring to FIG. 3, the scan driver may include a reflection mirror 3110 and a motor 3120. The laser transceiver includes a laser emitter 3210 and a laser receiver 3220. Laser emitted by the laser emitter 3210 is reflected by the reflection mirror 3110 and hits an object 3300, and laser reflected by the object 3300 is received by the laser receiver 3220 via re-reflection by the reflection mirror 3110. The motor 3120 drives the reflection mirror 3110 to vibrate randomly within a predetermined angle range, thereby realizing random scanning of the laser transceiver. In addition, those skilled in the art may know that the reflection mirror 3110 may also be replaced by a light-transmitting mirror, and the light-transmitting mirror may be controlled by the motor 3120 to realize random scanning.

In the case of electronic phased scanning or electromechanical hybrid scanning, the scan driver drives the laser transceiver to vibrate randomly within a predetermined angle range through an optical path control device, or drives the laser transceiver to have a spatial angle change greater than 1.5 times a spatial angle change from a previous scan during at least one scan. The optical path control device includes, but is not limited to, at least one of an optical phased array (OPA), a microelectromechanical system (MEMS), a liquid crystal photoconductive device, a reflective liquid crystal light valve or a transmissive liquid crystal light valve.

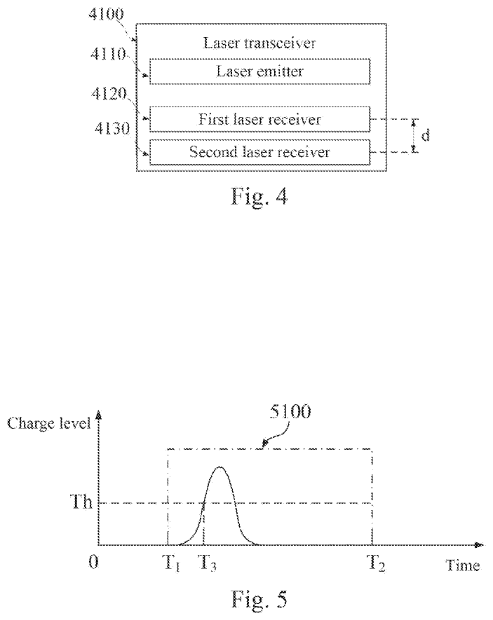

According to an embodiment of the present disclosure, each set of laser transceivers includes at least two laser receivers that are spatially separated from each other. Referring to FIG. 4, a laser transceiver 4100 may include a laser emitter 4110, a first laser receiver 4120 and a second laser receiver 4130. The first laser receiver 4120 and the second laser receiver 4130 may be spaced apart from each other by a distance d. Laser emitted by the laser emitter 4110 and reflected by an object may be received by the first laser receiver 4120 and the second laser receiver 4130. In this case, a distance of the object from the laser transceiver 4100 may be measured using a triangulation ranging method. In an application process, the triangulation ranging method may be used independently to obtain the distance information, or the distance information may be jointly generated by using time-of-flight and the triangulation ranging.

According to an embodiment of the present disclosure, the laser receivers of each set of laser transceivers also determine light intensity information of the laser reflected by the object. The processor may determine a material or a surface shape of the object based on the light intensity information of the reflected laser. The processor may also fine-tune the distance information determined by the laser receiver based on the light intensity information of the reflected laser. Accordingly, the position sensor may not record the light intensity information of the laser. For example, the position sensor may only record an orientation of the laser reflection point on the object, but not the intensity of the reflected laser. In addition, the number of pixels output by the position sensor may be less than half of a total number of pixels of the position sensor and greater than the number of pixels corresponding to the laser reflected by the object in each measurement, thereby reducing the burden of data processing and transmission.

According to an embodiment of the present disclosure, the position sensor includes a CMOS image sensor, a CCD image sensor, and an APD array, and the position sensor determines the orientation information of the object based on the laser reflected by the object during an exposure duration. Referring to FIG. 5, an exposure duration 5100 of the position sensor is shown. The exposure duration starts from T₁ and ends at T₂. During the exposure duration 5100, when a charge level of any pixel due to photoelectric conversion exceeds a predetermined threshold Th at time T₃, the position sensor records this trigger event and records coordinates of the pixel. The coordinates of the pixel contain the orientation information described above. The time T₃ of the trigger event is used to correspond to the orientation information measured by the position sensor and the distance information measured by the laser transceiver. At the same time, the position sensor may also record information related to a laser signal, such as the wavelength or the modulation of the laser, to identify the laser emitter of which set of laser transceivers the laser is coming from.

The position sensor may also include a high accuracy clock counter, and a minimum clock unit of the clock counter may be less than one tenth of the exposure duration, thereby recording the time T₃ that the laser reflected by the object reaches the transceiver in the exposure duration 5400 relative to the exposure start time T₁.

The method may be implemented through the following: recording the orientation information, based on the number of regions of a set of lasers having a strongest laser light intensity of a laser signal sensed within an exposure duration of the position sensor being greater than the number of emitted laser sources, and an intensity of any laser in the strongest set of lasers being greater than 1.5 times an intensity of any laser in a non-strongest set of lasers.

The recorded time of arrival of the laser may assist in generating the laser point cloud data. For example, when a time difference between the recorded time of arrival of the laser and a laser emission time corresponding to the laser emitter significantly deviates from a normal value range, it may be judged that this laser reception event is an abnormal event, such as light interference, electrical noise or hacking. In addition, the time difference between the recorded time of arrival of the laser and the laser emission time corresponding to the laser emitter may also be compared with the time of flight recorded by the laser transceiver, so as to correct the distance information.

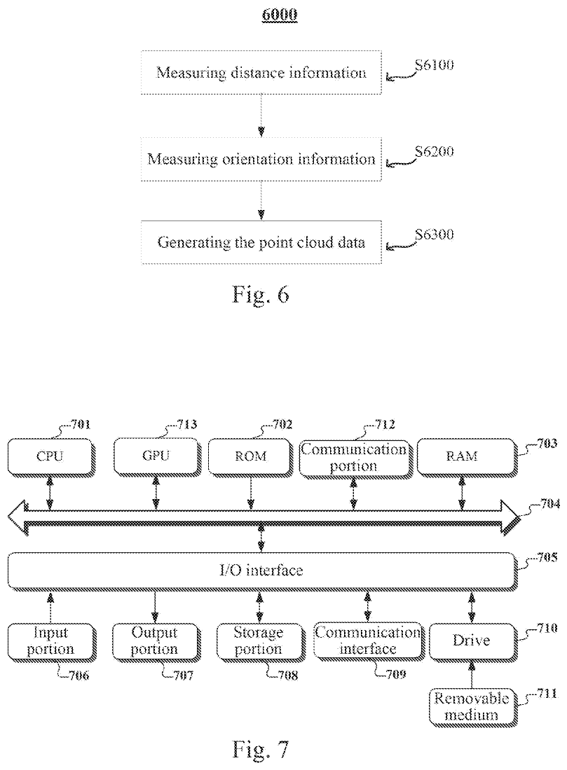

FIG. 6 shows a method 6000 for generating laser point cloud data based on the above laser radar. The method 6000 includes: in operation S6100, measuring, using a laser transceiver, distance information of an object away from the laser transceiver; in operation S6200, measuring orientation information of the object based on a position sensor independent of the laser transceiver; and in operation S6300, generating the laser point cloud data of the object based on the distance information and the orientation information.

According to an embodiment of the present disclosure, the laser transceiver includes a laser emitter and a laser receiver. Measuring the distance information includes: emitting laser using the laser emitter; receiving the laser emitted by the laser emitter and reflected by the object using the laser receiver; and determining the distance information based on a time of flight of the reflected laser.

According to an embodiment of the present disclosure, the laser transceiver includes at least two laser receivers that are spatially separated from each other. Measuring the distance information further includes: determining jointly the distance information based on positions of the at least two laser receivers and the time of flight.

According to an embodiment of the present disclosure, the laser transceiver includes at least two sets of laser transceivers, and the method includes: configuring a different laser wavelength or modulation for each set of laser transceivers.

According to an embodiment of the present disclosure, the scanning is spatial random scanning.

According to an embodiment of the present disclosure, the method further includes: determining a material or a surface shape of the object based on light intensity information of the reflected laser.

According to an embodiment of the present disclosure, measuring the orientation information of the object includes: recording the orientation information based on an intensity of a laser signal sensed within an exposure duration of the position sensor being greater than a predetermined threshold.

According to an embodiment of the present disclosure, the method further includes: recording a time that the laser reflected by the object reaches the transceiver in the exposure duration relative to an exposure start time, and assisting measuring the distance information based on the time.

Referring to FIG. 7, the present disclosure also provides a block diagram of a processing circuit serving a laser radar, for example, the processing circuit may be integrated into a trip computer of an automobile or a laser radar. The processing circuit includes one or more processors, communication portions, etc., the one or more processors such as one or more central processing units (CPUs) 701, and/or one or more graphics processing units (GPUs) 713. The processor may perform various appropriate actions and processes based on executable instructions stored in a read-only memory (ROM) 702 or executable instructions loaded from a storage portion 708 into a random access memory (RAM) 703. A communication portion 712 may include, but is not limited to, a network card, and the network card may include, but is not limited to, an IB (Infiniband) network card.

The processor may communicate with the read-only memory 702 and/or the random access memory 703 to execute executable instructions, connect with the communication portion 712 through a bus 704, and communicate with other target devices through the communication portion 712, thereby completing operations corresponding to any one of the methods provided in the embodiments of the present disclosure, for example: emitting laser using the laser emitter; receiving the laser emitted by the laser emitter and reflected by the object using the laser receiver; and determining the distance information based on a time of flight of the reflected laser.

In addition, in the RAM 703, various programs and data required for apparatus operation may also be stored. The CPU 701, the ROM 702, and the RAM 703 are connected to each other through the bus 704. In the case of the RAM 703, the ROM 702 is an optional module. The RAM 703 stores executable instructions, or writes the executable instructions into the ROM 702 at runtime, and the executable instructions cause the CPU 701 to perform operations corresponding to the above communication method. An input/output (I/O) interface 705 is also connected to the bus 704. The communication portion 712 may be integrated set, or may be set to have a plurality of sub-modules (e.g., a plurality of IB network cards), and be provided on the bus link.

The following components are connected to the I/O interface 705, including: an input portion 706 including a keyboard, a mouse, etc.; an output portion 707 including such as a cathode ray tube (CRT), a liquid crystal display (LCD), and a speaker, etc.; the storage portion 708 including a hard disk, etc.; and a communication interface 709 including a network interface card such as a LAN card, a modem. The communication interface 709 performs communication processing via a network such as the Internet. A drive 710 is also connected to the I/O interface 705 as needed. A removable medium 711, such as a magnetic disk, an optical disk, a magneto-optical disk, a semiconductor memory, is installed on the drive 710 as needed, so that a computer program read therefrom is installed into the storage portion 708 as needed.

It should be noted that the architecture shown in FIG. 7 is only an optional implementation. In the specific practice process, the number and type of the components in the above FIG. 7 may be selected, deleted, added or replaced according to actual needs; for the setting of different functional components, separate settings or integrated settings may also be adopted. For example, the GPU and the CPU may be set separately or the GPU may be integrated on the CPU, and the communication portion may be set separately or integrated on the CPU or the GPU, etc. These alternative embodiments all fall within the protection scope disclosed in the present disclosure.

In addition, according to the embodiments of the present disclosure, the processes described above with reference to the flowcharts may be implemented as computer software programs. For example, the present disclosure provides a non-transitory machine-readable storage medium having machine-readable instructions stored thereon, the machine-readable instructions are executable by a processor to perform instructions corresponding to the method steps provided in the present disclosure, for example: emitting laser using the laser emitter; receiving the laser emitted by the laser emitter and reflected by the object using the laser receiver; and determining the distance information based on a time of flight of the reflected laser. In such embodiments, the computer program may be downloaded and installed from a network via the communication interface 709 and/or installed from the removable medium 711. When the computer program is executed by the central processing unit (CPU) 701, the above functions defined in the method of the present disclosure are performed.

The method and apparatus, device of the present disclosure may be implemented in many methods. For example, the method and apparatus, device of the present disclosure may be implemented by software, hardware, firmware, or any combination of software, hardware, and firmware. The above order of steps for the method is for illustration only, and the steps of the method of the present disclosure are not limited to the order specifically described above unless stated otherwise. Furthermore, in some embodiments, the present disclosure may also be implemented as programs recorded in a recording medium, these programs comprising machine-readable instructions for implementing the method according to the present disclosure. Thus, the present disclosure also covers the recording medium storing the programs for performing the method according to the present disclosure.

The above description only provides an explanation of the embodiments of the present disclosure and the technical principles used. It should be appreciated by those skilled in the art that the protection scope of the present disclosure is not limited to the technical solutions formed by the particular combinations of the above-described technical features. The protection scope should also cover other technical solutions formed by any combinations of the above-described technical features or equivalent features thereof without departing from the concept of the technology. Technical schemes formed by the above-described features being interchanged with, but not limited to, technical features with similar functions disclosed in the present disclosure are examples.

What is claimed is:

1. A laser radar, the laser radar comprising:
a laser transceiver, wherein the laser transceiver comprises a laser emitter and a laser receiver, and the laser receiver determines distance information of the laser transceiver away from an object based on laser emitted by the laser emitter and reflected by the object;
a position sensor, the position sensor determining orientation information of the object based on the laser reflected by the object; and
a processor, the processor communicating with the laser transceiver and the position sensor respectively, and obtaining laser point cloud data of the object based on the distance information and the orientation information.

2. The laser radar according to claim 1, wherein the laser transceiver comprises at least two sets of laser transceivers, and the at least two sets of laser transceivers scan independently of each other, and the at least two sets of laser transceivers nonuniformly divide a total field-of-view of the laser radar.

3. The laser radar according to claim 1, wherein the laser transceiver has a nonuniform scanning step size.

4. The laser radar according to claim 2, wherein a wavelength of laser corresponding to each set of laser transceivers of the at least two sets of laser transceivers is different from a wavelength of laser corresponding to other laser transceivers; or
a modulation of laser corresponding to each set of laser transceivers of the at least two sets of laser transceivers is different from a modulation of laser corresponding to other laser transceivers.

5. The laser radar according to claim 4, wherein laser receivers of the each set of laser transceivers comprise filters that filter the laser corresponding to the other laser transceivers.

6. The laser radar according to claim 1, wherein the laser radar comprises a scan driver corresponding to the laser transceiver, and the scan driver drives the laser transceiver to perform a random scanning operation without preset direction information of laser emission; and
the scan driver comprises:
at least one of a reflection mirror and a light transmission optics, the at least one of the reflection mirror and the light transmission optics controls an emission direction of the laser corresponding to the laser transceiver; and
a motor, wherein the motor drives at least one of the reflection mirror and the light transmission optics to move randomly within a predetermined angle range.

7. The laser radar according to claim 6, wherein the scan driver drives the laser transceiver to move randomly within a predetermined angle range through an optical path control device, or drives the laser transceiver to have a spatial angle change greater than 1.5 times a spatial angle change from a previous scan during at least one scan; and
the optical path control device comprises at least one of: an optical phased array, a microelectromechanical system, a liquid crystal photoconductive device, a reflective liquid crystal light valve or a transmissive liquid crystal light valve.

8. The laser radar according to claim 1, wherein the laser transceiver comprises at least two laser receivers that are spatially separated from each other; and the laser transceiver also determines light intensity information of the laser reflected by the object.

9. The laser radar according to claim 1, wherein a number of pixels output by the position sensor is less than half of a total number of pixels of the position sensor and greater than a number of pixels corresponding to the laser reflected by the object in each measurement.

10. The laser radar according to claim 1, wherein the position sensor comprises a CMOS image sensor, and/or a CCD image sensor, a clock counter and an APD array, the position sensor determines the orientation information of the object based on the laser reflected by the object during an exposure duration, and the clock counter records a time that the laser reflected by the object reaches the transceiver in the exposure duration relative to an exposure start time.

11. The laser radar according to claim 1, wherein the laser transceiver comprises at least two sets of laser transceivers, wherein at least one set of laser transceivers are Flash laser radars, and a field-of-view of the Flash laser radars is less than 0.75 times of a total field-of-view of a to-be-measured scenario measured by the laser radar.

12. A method for generating laser point cloud data, the method comprising:
measuring, using a laser transceiver, distance information of an object away from the laser transceiver;
measuring orientation information of the object based on a position sensor independent of the laser transceiver; and
generating the laser point cloud data of the object based on the distance information and the orientation information.

13. The method according to claim 12, wherein the laser transceiver comprises a laser emitter and a laser receiver, and measuring the distance information comprises:
emitting laser using the laser emitter;
receiving the laser emitted by the laser emitter and reflected by the object; and
determining the distance information based on a time of flight of the emitted and reflected laser.

14. The method according to claim 13, wherein the laser transceiver comprises at least two laser receivers that are spatially separated from each other, and measuring the distance information further comprises: determining jointly the distance information based on positions of the at least two laser receivers that are separated from each other and the time of flight.

15. The method according to claim 12, wherein the laser transceiver comprises at least two sets of laser transceivers, and the method comprises:
configuring a different laser wavelength or modulation for each set of laser transceivers.

16. The method according to claim 12, wherein measuring the distance information further comprises:
acquiring the distance information through scanning by the laser transceiver,
wherein, the scanning is spatial random scanning.

17. The method according to claim 13, wherein the method further comprises:
determining a material or a surface shape of the object based on light intensity information of the reflected laser.

18. The method according to claim 12, wherein measuring the orientation information of the object further comprises:
recording the orientation information based on an intensity of a laser signal sensed within an exposure duration of the position sensor being greater than a predetermined threshold; or
recording the orientation information, in response to a number of regions of a set of lasers having a strongest laser light intensity of a laser signal sensed within an exposure duration of the position sensor being greater than a number of emitted laser sources, and an intensity of any laser in the strongest set of lasers being greater than 1.5 times an intensity of any laser in a non-strongest set of lasers.

19. The method according to claim 18, wherein the method further comprises:
recording a time that the laser reflected by the object reaches the transceiver in the exposure duration relative to an exposure start time, and assisting measuring the distance information based on the time.

20. A system for generating laser point cloud data, the system comprising:
a memory, storing computer-readable instructions; and
a processor, connected to the memory, executing the instructions to perform operations as follows:
controlling the laser transceiver to measure distance information of an object away from the laser transceiver;
measuring orientation information of the object based on a position sensor independent of the laser transceiver; and
generating the laser point cloud data of the object based on the distance information and the orientation information.
